(19) United States
(12) Patent Application Publication
(10) Pub. No.: US 2010/0136358 A1
(43) Pub. Date: Jun. 3, 2010

(54) Polyol-based method for producing ultra-fine metal powders

(75) Inventors: Daniel V. Goia, Potsdam, NY (US); Daniel Andreescu, Potsdam, NY (US); Brendan P. Farrell, Potsdam, NY (US)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: NanoDynamics, Inc.

(21) Appl. No.: 11/796,291

(22) Filed: Apr. 27, 2007

Related U.S. Application Data
(63) Continuation of application No. PCT/US05/39242, filed on Oct. 31, 2005.
Application No. PCT/US05/39242 is a continuation of application No. 10/978,154, filed on Oct. 29, 2004, now abandoned.
Application No. 10/978,154 is a continuation of application No. 10/981,110, filed on Nov. 3, 2004, now abandoned.
Application No. 10/981,110 is a continuation of application No. 10/981,083, filed on Nov. 3, 2004, now abandoned.
Application No. 10/981,083 is a continuation of application No. 10/981,077, filed on Nov. 3, 2004, now abandoned.

(51) Int. Cl. B22F 1/00; B32B 15/02; B22F 9/20

(52) U.S. Cl. 428/546; 75/370

(57) ABSTRACT

The invention provides monodisperse ultra-fine metallic particles having a low degree of agglomeration and a high degree of crystallinity and oxidation resistance, and methods for forming such particles. The invention provides a method of controlling the size and size distribution of ultra-fine metal particles by regulating the pH of a polyol-type process. The methods of the invention make it possible to increase the metal loading in a polyol-type process without increasing particle size, enabling the production of ultra-fine metallic particles in high yield.

### RELATED APPLICATIONS

This application is a continuation of PCT International Patent Application Number PCT/US2005/039242, filed Oct. 31, 2005, which claims the benefit of U.S. Utility application Ser. No. 10/978,154, filed Oct. 29, 2004, and claims the benefit of U.S. Utility application Ser. No. 10/981,110, filed Nov. 3, 2004, and claims the benefit of U.S. Utility application Ser. No. 10/981,083, filed Nov. 3, 2004, and claims the benefit of U.S. Utility application Ser. No. 10/981,077, filed Nov. 3, 2004 and the entirety of these applications are hereby incorporated herein by reference for the teachings therein.

### FIELD OF THE INVENTION

The present invention relates generally to ultra-fine metallic powders and methods of making the same. The present invention further relates to methods of depositing ultra-fine metallic powders onto various substrates.

### BACKGROUND OF THE INVENTION

Ultra-fine metallic particles have many unique physical and chemical characteristics, which make them ideal materials for applications as varied as electronics, medicine, catalysis, metallurgy, and decoration. Among the various particle-producing techniques used in the art, methods based on chemical precipitation from solution provide several advantages, including low manufacturing cost and control of the mechanism of metal particle formation. Micron and submicron-size metallic powders of many metals such as Co, Cu, Ni, Au and Ag have been prepared using chemical techniques with a variety of reductants. A particularly versatile method is the so-called “polyol process”, which is based on the reduction of metal salts, oxides, or complexes by alcohols or polyols at elevated temperatures. See for example F. Fievet et al., Mat. Res. Soc. Bull. 14:29-34 (1989); L. Kurihara et al, Nanostructured Materials 5:607-613 (1995); and U.S. Pat. Nos. 4,539,041 and 5,759,230, which discuss the use of linear polyols to reduce various metal compounds into ultra-fine metal powders.

It is known to add dispersants to a polyol process reaction mixture in order to discourage particle agglomeration or sintering. Typical dispersants used in the prior art are amphiphilic or detergent-like materials, such as octylamine and octanoic acid, and polymers such as polyvinylpyridine. It has been suggested (U.S. Pat. No. 6,551,960) that amino alcohols might serve as the reductant in the preparation of metallic nanopowders.

These procedures, however, are characterized by rather low concentrations of metal precursors and the correspondingly excessive consumption of organic solvents per unit weight of metallic powder produced. Furthermore, the metallic powders produced using these procedures have a wide size distribution, a low degree of crystallinity, and in the case of the base metals, a pronounced tendency to oxidation.

### SUMMARY OF THE INVENTION

The present invention provides a metallic composition, which comprises a plurality of ultra-fine metallic particles (e.g., ultra-fine copper, nickel, or silver particles) having one or more desirable features, such as tight size distribution, a low degree of agglomeration, a high degree of crystallinity and oxidation resistance.

The present invention provides a method for forming compositions having a plurality of ultra-fine metallic particles (e.g., ultra-fine copper, nickel, or silver particles), and the metallic compositions produced thereby, where the method includes the steps of:
(a) providing a reaction mixture containing a metal precursor, a branched polyol dispersing agent, and an alcoholic reducing agent;
(b) adjusting the temperature of the reaction mixture to a reaction temperature sufficient to reduce the metal precursor to metallic particles;
(c) maintaining the reaction mixture at the reaction temperature for a time sufficient to reduce the metal precursor to metallic particles, thereby producing the plurality of ultra-fine metallic particles; and optionally,
(d) isolating the metal particles.

In another aspect, the present invention provides a substrate coated with a plurality of ultra-fine metallic particles (e.g., ultra-fine copper, nickel, or silver particles) having at least one desirable feature, such as tight size distribution, low degree of agglomeration, a high degree of crystallinity and oxidation resistance.

Also provided is a method of preparing such coated substrates, which comprises the steps of:
(a) providing a reaction mixture containing the substrate, a metal precursor, a branched polyol dispersing agent, and an alcoholic reducing agent;
(b) adjusting the temperature of the reaction mixture to a reaction temperature sufficient to reduce the metal precursor to metallic particles; (c) maintaining the reaction mixture at the reaction temperature for a time sufficient to reduce the metal precursor to metallic particles and permit the resulting metal particles to form a coating on the surface of the substrate, thereby producing the coated substrate; and optionally,
(c) isolating the coated substrate.

The metal precursor may be any metal-containing substance that is subject to reduction to the zero-valent metal by an alcoholic reducing agent, including but not limited to metal salts, metal oxides or hydroxides, and metal complexes. The branched polyol dispersing agent may be a branched polyol such as 1,1,1-tris(hydroxymethyl)ethane, 1,1,1-tris(hydroxymethyl)propane, 2-methylthreitol, 2-methylerythritol, or pentaerythritol. In certain embodiments, the reaction mixture may further contain one or more additional dispersing agents, such as linear polyols (e.g., sorbitol and/or mannitol) and salts of naphthalene sulfonic acid/formaldehyde co-polymers. The alcoholic reducing agent may be any alcoholic reductant known in the art of metal powder production, including but not limited to 1,2-propylene glycol, 1,3-propylene glycol, diethyleneglycol, or combinations thereof. The method of the present invention may optionally be carried out with control of the pH of the reaction mixture (e.g., by introducing a buffering agent, such as triethanolamine).

In another aspect, the present invention provides a method of controlling the size of ultra-fine metallic particles formed by reduction of metal precursors in a liquid, which comprises moderating the pH of the reaction mixture, preferably by introduction of a buffering agent into the liquid prior to or during the reduction process. In one embodiment, the ultra-fine metallic particles are formed by reducing a metal precursor in a buffered liquid containing an alcoholic reducing agent. The buffered liquid preferably contains a branched dispersing agent.

The invention provides improvements to the known processes for preparing metal powders by reduction of metal precursors with an alcoholic reducing agent. Among the improvements are (a) carrying out the reduction in a solvent comprising two or more glycols; (b) carrying out the reduction in the presence of a tertiary amine buffer; and (c) carrying out the reduction in the presence of a branched polyol dispersing agent. These improvements may be employed alone or in combination, preferably in combination. The improvements make it possible to produce ultra-fine metallic particles in a concentrated reaction mixture.

Other features and advantages of the present invention will become apparent from the following detailed description. It should be understood, however, that the detailed description and the specific examples, while indicating the preferred embodiments of the invention, are given by way of illustration only. Various changes and modifications within the spirit and scope of the invention will become apparent to those skilled in the art from this detailed description.

### BRIEF DESCRIPTION OF THE FIGURES

FIG. 1 is a series of field emission scanning electron micrographs that show the effects of buffering agent TEA on copper particles produced by a method in accordance with one embodiment of the present invention, where the reaction mixture includes 50% 1,2-PG, 50-x % DEG, and x % TEA. (a) x=0; (b) x=1.5; (c) x==5; (d) x=10.

FIG. 2 shows the effects of buffering agent TEA on the size of copper particles produced according to one embodiment of the present invention.

FIG. 3 illustrates the effects of various polyol compositions on the size of the copper particles produced according to one embodiment of the present invention, where the reaction mixture includes (a) 1,2-PG and TEA (90:10, v/v); (b) 1,2-PG, 1,3-PG, and TEA (50:40:10, v/v, respectively); and (c) 1,2-PG, DEG, and TEA (50:40:10, v/v, respectively). Images were acquired using a scanning electron microscope at two magnifications (5,000× and 10,000×).

FIG. 4 demonstrates the effects of changing the concentration of the copper salt on the size of the copper particles, where the reaction mixture includes: (a) 0.174 g/cm³ CuCO₃; (b) 0.261 g/cm³ CuCO₃; (c) 0.348 g/cm³ CuCO₃; and (d) 0.400 g/cm³ CuCO₃. (SEM images, 500O× magnification, scale bar=5 μm).

FIG. 5 contains the typical XRD pattern of highly crystalline copper particles produced according to one embodiment of the present invention, displaying a pronounced split of the (220), (311), and (222) reflections.

FIG. 6 shows the SEM images of nickel particles produced according to one embodiment of the present invention.

### DETAILED DESCRIPTION OF THE INVENTION

As used herein and in the appended claims, the singular forms “a,” “an,” and “the” include plural references unless the content clearly dictates otherwise. Thus, for example, reference to “a particle” includes a plurality of such particles and equivalents thereof known to those skilled in the art, and reference to “the polyol” is a reference to one or more polyols and equivalents thereof known to those skilled in the art, and so forth. All publications, patent applications, patents and other references mentioned herein are incorporated by reference in their entirety.

The present invention provides ultra-fine metallic particles having at least one desirable feature, such as, a tight size distribution, a high degree of crystallinity, oxidation resistance, and a low degree of agglomeration. The present invention further provides a method for producing such ultra-fine metallic particles. The present invention also provides a more cost-effective chemical method for producing ultra-fine metallic powders than those presently known in the art, by reducing metal precursors with an alcoholic reducing agent at higher metal concentrations than those previously used in the art to produce particles with substantially the same sizes. The concentrated reaction mixtures of the present invention may therefore be used to reduce the cost of making ultra-fine metallic particles, particularly costs related to energy, resources, and waste treatment.

As used herein and in the appended claims, the term “ultra-fine particles” generally includes particles having diameters of about 1 nm-10 μm, preferably about 10-5,000 nm, more preferably 50-3,000 nm, and most preferably 100-1000 nm. The ultra-fine metallic particles may comprise various metals, including those transition metals and noble metals, such as Ag, Au, Co, Cu, Fe, In, Ir, Mn, Mo, Ni, Os, Pd, Pt, Re, Rh, Ru, Sn, Ta, W, and combinations thereof, that are known to be amenable to preparation by the polyol process. In preferred embodiments, the metallic particles consist essentially of a single metal, most preferably selected from the group consisting of Cu, Ni, and Ag.

The methods of the present invention produce a substantially monodisperse ultra-fine metallic powder composition, i.e. a plurality of particles having a tight size distribution. The breadth of the size distribution, as used herein, refers to the degree of variation in the diameter of the particles in a metallic powder composition. The ultra-fine metallic powders of the invention may be deemed to have a tight size distribution when the diameters of at least about 80% of the particles are within the range N ±15% N, where N is the average diameter of the particles. In certain embodiments, at least about 85% of the particles are within the range N ±15% N, and in other embodiments at least about 90% of the particles are within the range N ±15% N. In optimum cases, 95% or more of the particles are within the range N 15% N. The diameters of the ultra-fine metallic particles may be measured by a number of known methods, such as by electron microscopy with a scanning electron microscope.

The metallic powders produced in accordance with the present invention may comprise ultra-fine metallic particles that have a low degree of agglomeration. The degree of agglomeration may be expressed using the index of agglomeration I_{aggl}, which is the ratio between the average particle size distribution (“PSD50%”) and the average diameter of the particles. The average particle size distribution may be determined by any methods known in the art that measure particle agglomerates, including, but not limited to, dynamic light scattering (DLS), laser diffraction, and sedimentation methods, while the average particle diameter is determined by averaging the diameters of the individual metallic particles, e.g. as determined by electron microscopy. An I_{aggl} value of 1.0 indicates completely lack of agglomeration, while an increase in I_{aggl} value indicates an increase in the degree of aggregation. In preferred embodiments, the powders of ultra-fine metallic particles of the present invention have an I_{aggl} value of about 1.2 or less.

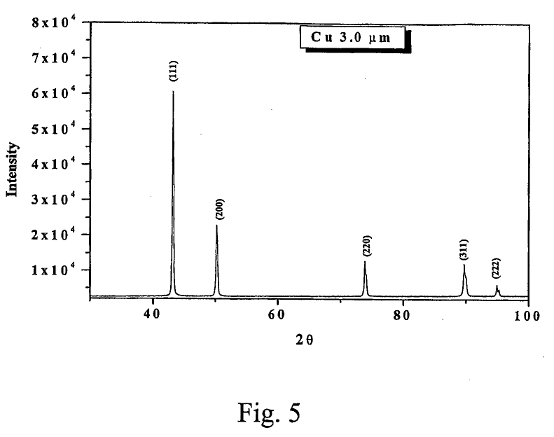

The metallic powders produced in accordance with the present invention may also include ultra-fine metallic particles that have a high degree of crystallinity. The term “degree of crystallinity,” as used herein and in the appended claims, generally refers to the ratio between the size of the crystallites in the metallic powder and the diameter of the metallic particles. The size of the constituent crystallites may be deduced from XRD measurements using the Sherrer equation, while the particle size may be determined by electron microscopy. A larger ratio of the size of the crystallites in comparison to the diameter of the metallic particles indicates an increased degree of crystallinity and a lower internal grain boundary surface. In one embodiment, the ultra-fine metallic particles have a high degree of crystallinity of at least about 80%, preferably at least about 85%, more preferably at least about 90-95%, and most preferably about 99-100% of the ultra-fine metallic particles of the present invention are highly crystalline. The high degree of crystallinity is reflected by the visible splitting of the peaks corresponding to the (220), (311), and (222) reflections in the XRD spectrum of a copper powder prepared according to the invention (FIG. 5).

The metallic powders produced in accordance with the present invention include oxidation-resistant ultra-fine particles of base metals that are normally sensitive to surface oxidation upon exposure to air in powder form. In one embodiment, the ultra-fine base metal particles undergo insubstantial oxidation when exposed to the air in an ambient indoor environment (20° C.) for 12 months or longer. In another embodiment, the ultra-fine base metal particles of the present invention undergo insubstantial oxidation when exposed to a temperature of up to about 100° C. in air for about 120 minutes. In still another embodiment, the oxidation of the ultra-fine base metal particles may be insubstantial when they are heated in the air at 20° C./minute to about 200-220° C. As used herein, the term “base metal” refers to metals that are susceptible to surface oxidation on prolonged exposure to air, including Co, Cu, Fe, In, Mn, Mo, Ni, Sn, Ta, W, and combinations thereof, and that are known to be amenable to preparation by the polyol process. Preferred embodiments include the elements Bi, Cu, Ni, Co, and Fe. Oxidation is considered insubstantial if the ultra-fine base metal particles display an increase of less than about 5-10% in their oxygen content as measured with an oxygen analyzer (LECO Corp., St. Joseph, Mich.).

The present invention also provides methods for producing ultra-fine metallic particles that comprise the steps of: (a) providing a reaction mixture containing a metal precursor, a branched polyol dispersing agent, and an alcoholic reducing agent; (b) adjusting the temperature of the reaction mixture to a reaction temperature sufficient for reduction of the metal precursor to metal particles; (c) maintaining the reaction mixture at the reaction temperature for a time sufficient to reduce the metal precursor the to metal particles, thereby producing a plurality of ultra-fine metallic particles; and optionally, (d) isolating the metal particles.

In one embodiment, the method of the present invention further includes controlling particle size and size distribution by moderating the pH of the reaction mixture. The pH of the reaction mixture is maintained above about 6, preferably above about 7, more preferably above about 8, and most preferably between about 8 and about 9. The moderation of pH is preferably achieved by introducing a buffering agent. Suitable buffering agents include but are not limited to alkaline salts of weak acids, such as citrate and phosphate, and amines, such as pyridine, triethanolamine and tris(hydroxymethyl)aminomethane. The buffering agent is preferably a tertiary amine, more preferably triethanolamine. The buffering agent may be added prior to initiation of the reduction of the metal precursor, and be present throughout the reaction, or it may be added gradually, in portions or continuously, for example according to a schedule or under control of a pH-stat. As used herein, the term “pH”, as applied to the glycol- and alcohol-based reaction mixtures of the present invention, refers to the apparent pH as indicated on a standard pH meter when a glass calomel reference electrode is immersed in the reaction mixture. [0028] Alkali metal hydroxides have previously been incorporated into polyol process reaction mixtures, but while an excess of hydroxide can drive the pH to high values, the hydroxide ion has no buffering capacity and cannot moderate the pH of the mixture. The pH of a mixture with added hydroxide will initially be very high, and will swing without moderation to a low value if protons generated in the course of the reaction consume the added hydroxide. Thus, for the purposes of this invention disclosure, the addition of an alkali metal hydroxide to the reaction mixture does not constitute moderation of the pH, unless the hydroxide is added under the control of a pH-stat.

The process of the present invention may be used to manufacture ultra-fine particles of various metals, including but not limited to Ag, Au, Co, Cr, Cu, Fe, In, Ir, Mo, Ni, Nb, Os, Pd, Pt, Re, Rh, Ru, Sn, Ta, Ti, V, and W, and alloys or composites containing these metals. A metal precursor is mixed with an alcoholic reducing agent, which converts the metal precursor to ultra-fine metal particles under the appropriate reaction conditions. Catalysts may optionally be present to accelerate the reduction of certain metals. The term “alcoholic composition” or “alcoholic reducing agent,” as used herein and in the appended claims, generally encompasses both monohydroxylic and polyhydroxylic alcohols (polyols), particularly those known in the art to be suitable for use in the “polyol process” of metal powder preparation. The reducing agent is preferably a polyol, and more preferably a diol. Suitable alcoholic reducing agents include, but are not limited to, ethylene glycol, diethylene glycol, 1,2-propylene glycol, 1,3-propylene glycol, 1,2-butanediol, and 1,4-butanediol. The reducing agent is preferably a 1,2-diol ranging from ethylene glycol to 1,2-hexadecanediol, and will preferably have a boiling point above whatever temperature is sufficient to effect reduction of the metal precursor. Most preferably a mixture of polyols is used, as described in detail below.

The metal precursor used in the reaction depends upon the particular metal itself and the type of ultra-fine metal particle product desired. As used herein, the term “metal precursor” refers to any metal-containing compound or complex that can be reduced to the elemental metal under the reaction conditions of the polyol process. The precursor need not be completely soluble in the reaction mixture. Suitable precursors include, but are not limited to, metal carbonates, metal formates, metal acetates, metal halides, metal nitrates, metal oxides, metal oxalates, metal hydroxides, metal acetylacetonates, and metal-based oxyanions (e.g., tungstate, molybdate) and haloanions (e.g., hexachloroplatinate, tetrachloronickelate) in acid or salt form. The metal precursor is preferably a metal carbonate. Precursors may be used in hydrous or anhydrous form.

In certain preferred embodiments, metal carbonates, such as CuCO₃, NiCO₃, CoCO₃, and Ag₂CO₃, are used as the metal precursor for producing ultra-fine particles of Cu, Ni, Co, and Ag, respectively. The use of metal carbonates is thought to be helpful in providing uniform metallic particles at high metal concentrations, as the carbonate counter ions may decompose to CO₂ and leave the system, rather than accumulating as the reduction proceeds. Consequently, the ionic strength of the reaction system does not increase substantially during the reaction, which promotes uniformity of product and stabilization of the metallic particle dispersion. In another embodiment, a mixture of metal precursors, such as metal carbonates and metal acetates or metal salycilates may be used for the production of ultra-fine metallic particles. The inventors have found that the presence of organic counter ions, such as acetate and salycilate, can enhance the stability of the metallic particles at high concentrations of metal ions. Accordingly, in yet another embodiment, agents which provide organic counter ions such as acetate or salicylate may be added to the reaction system of the present invention.

The inventors of the present invention have discovered that, compared to the use of linear polyol dispersants, the presence of a branched polyol in the reduction reaction leads to the generation of metallic particles with a tighter size distribution, a lower degree of agglomeration, a high degree of crystallinity, and less susceptibility to oxidation. The branched polyol may be used alone or as a mixture of branched and linear polyols, or as a mixture of branched polyols and ammonium or sodium salts of polynaphtalene sulfonic acid/formaldehyde co-polymers.

The terms “branched dispersing agent” and “branched polyol” as used herein and in the appended claims refer to a polyol which has a non-linear carbon chain. Preferably, at least one side group on the branched polyol comprises a hydroxymethyl group. Branched polyols suitable for the process of the present application include but are not limited to 2-methylthreitol, 2 methyl erythritol, 1,1,1-tris(hydroxymethyl)ethane, 1,1,1-tris(hydroxymethyl)propane, tris(hydroxymethyl)aminomethane, and pentaerythritol (“PE”). Branched polyols may have multiple roles in the reaction mixture, including functioning as a reducing agent as well as a dispersant. In preferred embodiments, the branched polyol is pentaerythritol. The term “linear polyols” includes, without limitation, molecules containing linear chains of about 3 to about 7 carbon atoms, with three or more carbons having a hydroxyl group attached, including but not limited to sorbitol and mannitol. Suitable polynaphthalene sulfonic acid/formaldehyde copolymers include, but are not limited to, Daxad™ 1 IG and other Daxad™ brands of polynaphthalene sulfonic/formaldehyde co-polymers.

Specific reducing polyols and polyol compositions used in the process of the present invention may be required by a particular reactions, but in general a broad range of polyols may be used in the process, such as the polyols disclosed in U.S. Pat. Nos. 4,539,041 and 5,759,230, each of which is hereby incorporated herein by reference in its entirety. The polyols may be in either liquid or solid form. In certain embodiments, 1,2-propylene glycol (“1,2-PG”), 1,3-propylene glycol (“1,3-PG”), diethyleneglycol (“DEG”), or combinations thereof, may be used in the reaction mixture. In another embodiment, a mixture of 1,2-PG and DEG may be used as the reducing polyol.

When preparing the reaction mixture, the branched dispersing agent and the alcoholic reducing agent may be heated or unheated. Generally, the reaction temperature will be maintained or adjusted to between 80° C. and 350° C., more preferably between 110° C. and 200° C. For example, to produce ultra-fine Cu particles, 1,2-PG, DEG, and PE may be mixed and heated to bring the temperature of the mixture to about 70° C. The required amount Of CuCO₃ may then be added into the polyol mixture at about 80-85° C. after PE is fully dissolved. The reaction mixture may further be heated to bring the temperature of the mixture to an appropriate reaction temperature. In the case OfCuCO₃, a suitable reaction temperature is about 180-185° C. Heating may be accomplished via an external heat source such as a heated bath or mantle, or by microwave irradiation as described in U.S. Pat. No. 6,746,510. The process may be carried out in batch mode or as a continuous process.

The resulting ultra-fine metal particles may be collected by standard protocols known in the art, such as by precipitation, filtration, and centrifugation. The particles may further be washed, such as by using methanol or ethanol, and dried, such as by air, N₂, or vacuum.

The size and the uniformity of the ultra-fine metallic particles are affected by a variety of factors, such as the types of metal precursor, branched polyol, alcoholic agent, and dispersant used, the concentration of the metal ions, the reaction temperature, and the pH of the reaction mixture. In certain embodiments, the pH of the reaction mixture may be adjusted to control the size of the ultra-fine metallic particles produced at any given metal precursor concentration. The inventors have discovered that pH changes significantly affect the reduction reaction and the formation of metallic particles. In a preferred embodiment, the pH of the reaction mixture is adjusted by adding a buffering agent. The term “buffering agent” as used herein refers to an agent which, upon addition to the reaction mixture, moderates changes of the reaction mixture pH caused by H⁺ produced during the reaction or when an acid or base is added into the reaction mixture. The buffering agent is added to the reaction mixture to stabilize the pH of the reaction mixture, in order to control the size of the particles produced by the reaction system at a given concentration of a metal precursor in the reaction mixture. The inventors have found that control of the pH of the reaction mixture makes it possible to produce smaller and more uniform particles than would otherwise be possible at a particular concentration of the metal precursor. Examples of suitable buffering agents include, without limitation, triethanolamine (“TEA”), 4-(2-hydroxyethyl)piperazine-1-ethanesulfonic acid (“HEPES”), 4-morpholinepropanesulfonic acid (“MOPS”), tris(hydroxymethyl)aminomethane (“Tris”), and N-[tris(hydroxymethyl)methyl]-2-aminoethanesulfonic acid (“TES”).

The inventors have discovered that the size of ultra-fine metallic particles formed by the process of the present invention may be significantly affected by the amount of buffering agent added to the reaction mixture. For example, in a typical reaction system with 1,2-PG (250 ml), DEG (250 ml), and CuCO₃ (200 g), the pH of the reaction mixture measured at room temperature in the absence of PE decreases from about 8.6 at the beginning of the process to about 4.85 at the end of the reaction and the average size of the copper particles product is about 2.4 μm. The addition of 2% TEA (final concentration) raised the final pH to about 6.20 and the size of the copper particles decreased to about 1.5 μm. When 5% and 10% of TEA (final concentration) was introduced into the reaction mixture, the pH at the end of the reaction was about 7.70 and about 8.60, respectively, and the size of the copper particles produced by the process was reduced to about 700 nm and about 300 nm, respectively.

The present inventors have also discovered that controlling of the pH of the reaction mixture during the reduction process dramatically reduces the cost of making ultra-fine metallic particles, by enabling the uses of a concentrated reaction system. The metal concentrations in prior art polyol processes have been kept low (typically below 5-10%) in order to form ultra-fine metal particles in the sub-micrometer scale. Such dilute systems consume more energy and materials to produce a given amount of ultra-fine metallic particles of a particular size than the concentrated system of the present invention. Furthermore, the concentrated system of the present invention reduces the cost of downstream processes, and reduces the cost of discarding or recycling waste organic solvent. The invention provides a method of preparing 200 g or more of an ultra-fine metal powder, having an average particle size of 1.2 μm or less, in only one liter of solvent.

For example, by employing the pH moderation methods of the present invention, about 100 g of Cu particles with a size of about 300 nanometers may be produced by reducing more than 200 g OfCuCO₃ in a reaction volume of only 500 ml (250 ml 1,2-PG, 200 ml DEG, and 50 ml TEA). When the same amount OfCuCO₃ is reduced in a reaction mixture where the pH is not moderated (250 ml 1,2-PG and 250 ml DEG), Cu particles with size of about 2.4 μm are formed.

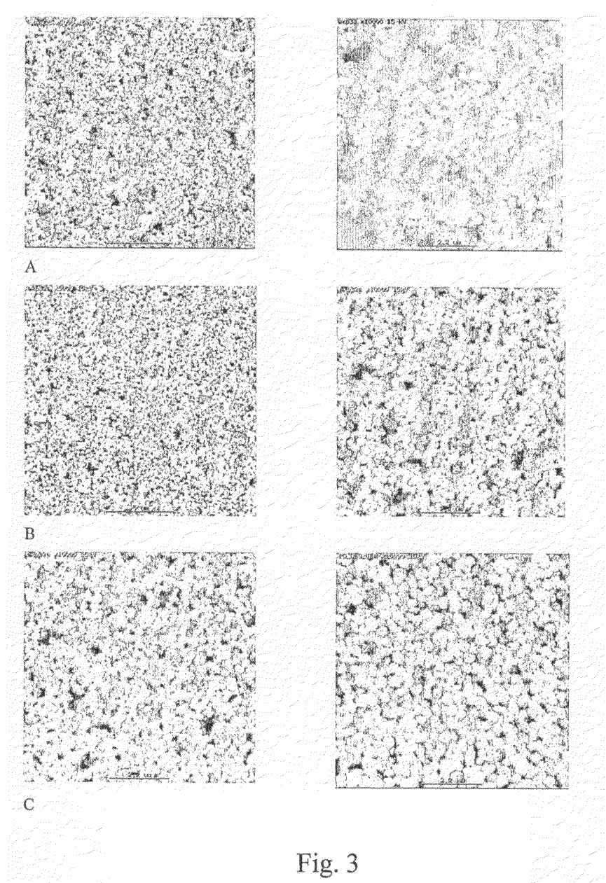

The inventors have also discovered that the types of polyol used in the process affect the size and uniformity of the metallic particles produced. For example, in a typical reaction, the ultra-fine copper particles formed in reaction mixture of 1,2-PG as the sole reducing polyol exhibit a wide particle size distribution (100-700 nm). The uniformity of the copper particles considerably improves when polyol mixtures, such as a mixture of 1,2-PG and 1,3-PG or a mixture of 1,2-PG and DEG, are used (see FIG. 3). The inventors have found that copper particles produced in a mixture of 1,2-PG and DEG have the highest uniformity (i.e., the tightest size distribution). Furthermore, compared to the use of 1,3-PG, the use of DEG resulted in larger copper particles (300 nm vs. 500 nm, respectively).

The present invention further provides a substrate coated with a plurality of ultra-fine metallic particles, where the plurality of ultra-fine metallic particles have at least one desirable feature, such as a tight size distribution, a low degree of agglomeration, a high degree of crystallinity, or oxidation resistance. The term “substrate” as used herein includes, without limitation, metallic subjects (e.g., metallic particles, flakes, tubes, and sheets), plastic materials, ceramic objects, fibers, films, glasses, polymers, organic materials (e.g. resins), inorganic materials (e.g., amorphous carbon and carbon nanotubes), and any other object capable of being coated with the ultra-fine metallic particles produced in accordance with the present invention. The ultra-fine metallic particles may be particles of various metals, preferably Cu, Ni, or Ag.

The present invention also provides a method of coating a substrate with a plurality of ultra-fine metallic particles, by: (a) forming a reaction mixture containing the substrate, a metal precursor, a branched dispersing agent (e.g., a branched polyol), and an alcoholic reducing agent; (b) adjusting the temperature of the reaction mixture to a reaction temperature sufficient to reduce the metal precursor to metal particles; (c) maintaining the reaction mixture at the reaction temperature for a time sufficient to reduce the metal precursor to metal particles and permit the resulting metal particles to form a coating on the surface of the substance; and optionally, (d) isolating the coated substance. In one embodiment, the ultra-fine metallic particles may be introduced to the surface of the substrate in such a manner that they form a uniform and continuous layer(s) the surface. For example, the methods described in U.S. Pat. No. 6,746,510, incorporated herein by reference, may readily be adapted to the methods of the present invention.

### EXAMPLES

The following examples are set forth to illustrate the invention and as an aid to understanding the invention, and should not be construed to limit in any way the scope of the invention as set forth in the appended claims. Such modifications and equivalents as will be apparent to those skilled in the art are intended to be within the scope of the invention.

Materials. Copper carbonate (CuCO₃) and nickel carbonate (NiCO₃) were supplied by Shepherd Chemical Co. (Norwood, Ohio, U.S.A.). Palladium chloride solution (PdCl₂) was obtained from OMG (South Plainfield, N.J., U.S.A.). 1,2-PG and DEG were obtained from Alfa Aesar (Ward Hill, Mass., U.S.A.). 1,3-PG and PE were obtained from Avocado Research Chemicals Ltd. (Heysham, Lancashire, UK), and TEA was purchased from Aldrich (Milwaukee, Wis., U.S.A.).

### Example 1

### Copper Particle Synthesis

All experiments were carried out in a 1-liter, 4-necked round flask equipped with a Dean Stark trap and a reflux condenser. The stirring was provided by a two-inch Teflon blade connected to a variable speed mixer. The amount of cupric carbonate used in the precipitation process was in general kept at 200 g (1.62 mole) although smaller or larger amounts were occasionally used as well (e.g., 87 g or 300 g). CuCO₃ was added to 500 ml of polyol or a polyol mixture, containing 15 g PE (for 200 g CuCO₃). The dispersant agent (PE) was initially added to the polyol(s) and heated at a low power (10%) with a heating mantle to bring the temperature to 70° C. The required amounts OfCuCO₃ were added into the flask at 80-85° C. after PE was fully dissolved. The CuCO₃/polyol mixture was stirred at 500 RPM in all experiments. The mixture was then heated at 50% power until the temperature reached 180-185° C. The copper particles obtained were washed three times with ethanol (3×400 mL) and were filtered using a vacuum system and Whatmann #50 filter paper. The particles were then dried overnight at 80° C. in a regular oven.

### Example 2

### Particle Characterization

The morphology of the copper particles was investigated by scanning electron microscopy (SEM) using a JEOL JSM-6300 scanning microscope at 15 kV accelerating voltage and the magnification between 2500 and 10000. Copper powders were also analyzed by field emission scanning electron microscopy (FE-SEM) with 5 kV accelerating voltage and the same range of magnification using a JEOL JSM-7400F field emission scanning electron microscope.

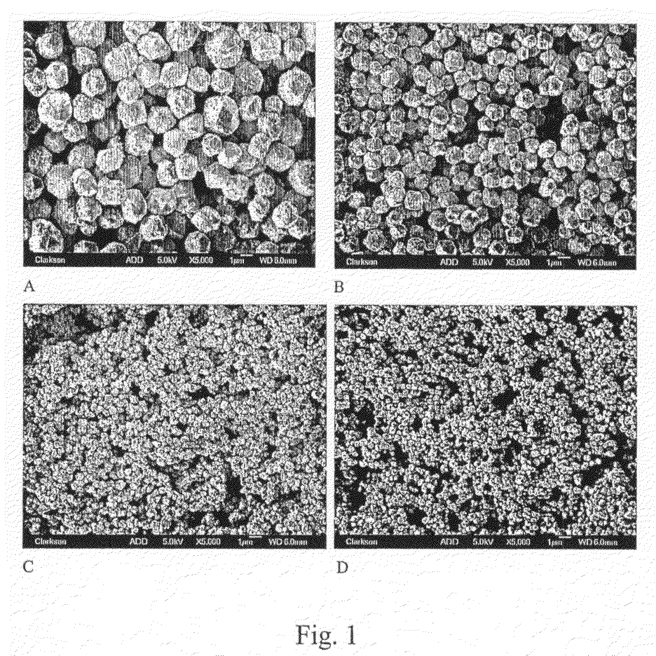

In order to evaluate the effect of pH on the formation of Cu particles in polyols, variable amounts of triethanolamine (TEA) were added into the dispersion of CUCO₃ prior to heating, as shown in Table 1. The reaction time in the presence of TEA varied between 3 and 4 hours; the addition of more base tending to speed up the reaction. The particles sizes shown in Table 1 were obtained by averaging the size of minimum 50 particles generated in each experiment. Images of copper particles produced in these experiments, obtained by FE-SEM, are illustrated in FIG. 1.

Almost all copper particles prepared by the reduction of copper carbonate in polyols or mixtures of polyols in the presence of TEA were isometric and very crystalline in shape. Their diameter varied from several hundred nanometers (200-300 nm) to several micrometers (2-3 μm) depending on the amount of TEA added to the reaction mixture. In all experiments containing TEA, the copper particles retained the morphology obtained in the absence of TEA (pH=4-5).

In order to evaluate the influence of different polyol compositions in the preparation of copper particles, several experiments were carried out using pure 1,2-PG and mixtures of 1,2-PG with DEG and 1,3-PG. In all of these experiments 10% TEA and the same amounts of PE (7 g) and CuCO₃ (87 g) were used. FIGS. 3a-3c show, at two magnifications (5000× and 10000×), the SEM images of the copper particles formed in a 1,2-PG:DEG:TEA mixture (50:40:10, v/v/v, respectively) and a 1,2-PG:1,3-PG:TEA mixture (50:40:10, v/v/v, respectively). For comparison, FIG. 3 includes also the SEM of copper particles obtained in a 1,2-PG:TEA mixture (90:10, v/v). Table 1-Experimental condition and characteristics of the copper powder obtained in polyol mixtures containing TEA.

* Final pH as measured at room temperature at the end of the reaction.

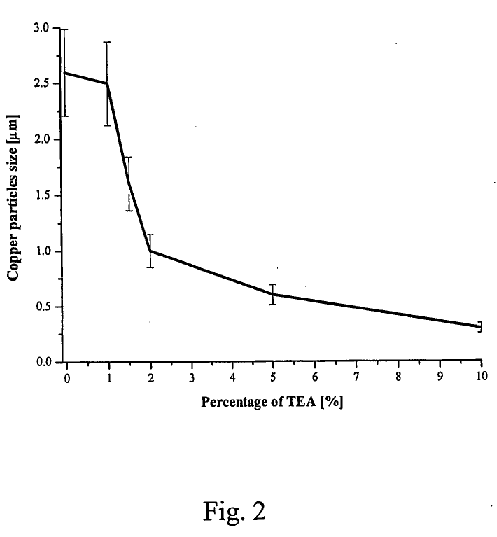

The changes in the average diameter of copper particles produced as a function of the concentration of TEA are illustrated in FIG. 2. The differences in average diameter of particles obtained under similar experimental conditions with different lots OfCuCO₃ are −10%.

The SEM analysis showed copper particles formed in a 1,2-PG/TEA mixture have the widest particle size distribution (100-700 nm). The uniformity of the copper particles improved when polyol mixtures were used. It appears that the nature of the second polyol affects the size of the particles: the addition of DEG generated larger particles (0.5 μm) than did 1,3-PG (0.3 μm). The results of this set of experiments suggest that the addition of DEG leads to the most uniform copper particles.

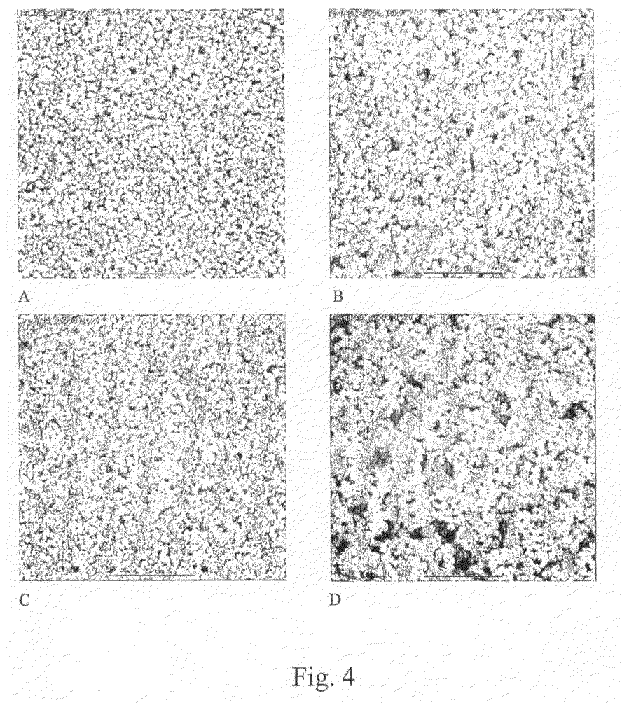

The present inventors have previously shown that when the amount OfCuCO₃ is changed, the size of the copper particles decreases with a decrease in the concentration of the Cu ions in the system. This trend tends to increase in the cost of producing ultra-fine Cu particles with a decreased size. In more concentrated systems, the pH of the reaction mixture decreases significantly as the reduction proceeds, causing a decrease in the reducing power of the polyol and a slowdown in the reaction rate of the second stage of the copper reduction (Cu⁺—>Cu⁰). The inventors have demonstrated that fine copper particles can be produced even in highly concentrated systems, provided that the pH of the reaction mixture is controlled. In order to evaluate the influence OfCuCO₃ concentration on copper particle size, a systematic study was carried out using 87 g (0.174 g/cm³), 130.5 g (0.261 g/cm³), 174 g (0.348 g/cm³), and 200 g (0.40 g/cm³) Of CuCO₃ in the reduction processes. For all experiments a fixed amount of PE (7 g) and a fixed 1,2-PG:DEG:TEA ratio (250:200:50, v/v) were used. The pH of the initial slurry did not change with the amount of carbonate used and it decreased only slightly during the reduction process. The SEM pictures (at 500O× magnification) of copper particles obtained at different CuCO₃ concentrations are illustrated in FIG. 4.

The average size of the copper particles was ca. 0.5 μm for all the CuCO₃ concentrations tested, the differences between separate preparations being less than ±20%. A better homogeneity was observed at the lowest concentration, probably because of the higher dispersant:metal ratio.

These results further confirm the hypothesis that the rate of the reduction with polyols is pH-dependent, and that by controlling the pH during the reaction the size of the resulting Cu particles can also be controlled. The discovery provided by the present invention may have significant implications in the production of ultra-fine Cu powders since it enables a manufacturing method which may be easily scaled up to produce ultra-fine Cu powder at very competitive prices.

Among the factors that affect the size of copper particles produced by the chemical reduction of copper carbonate in polyols and/or polyols mixtures, one of the most influencing factors is the pH of the solution. The inventors demonstrated that this parameter can be adjusted by adding TEA in controlled concentrations. At high pH values (8.6-9.0), such as when 10% TEA was added into the reaction mixture, smaller copper particles (size range 0.2-0.5 μm) were formed, and the sizes of copper particles increased with decreasing pH. The size of the copper particles was not substantially affected by the changes of pH when the value of the pH of the reaction mixture was less than 5.75 or higher than 8.5.

Another factor that influences particle size is the composition of the polyol mixtures used in the precipitation process. When copper particles were synthesized in a single polyol (e.g., 1,2-PG), a broad size distribution was obtained (1.5-2.6 μm). Surprisingly, the uniformity of copper particles obtained in polyol mixtures was improved, the narrowest distribution (2-2.8 μm) being obtained in 1,2-PG:DEG mixtures (FIG. 3).

Yet another factor that influences the size of the particles is the CuCO₃ concentration. When the pH of the system was not controlled, the diameters of the Cu particles varied significantly with the concentrations of the Cu precursor. However, when the pH was controlled by adding a buffering agent, the size of the copper particles was relatively stable over a wide range Of CuCO₃ loading (0.174-0.40 g/cm³). An approximately 10% increase in average diameter of copper particles was observed in experiments using a CuCO₃ loading of 0.40 g/cm³ (FIG. 4).

### Example 3

### Preparation of Ultra-Fine Nickel Particles

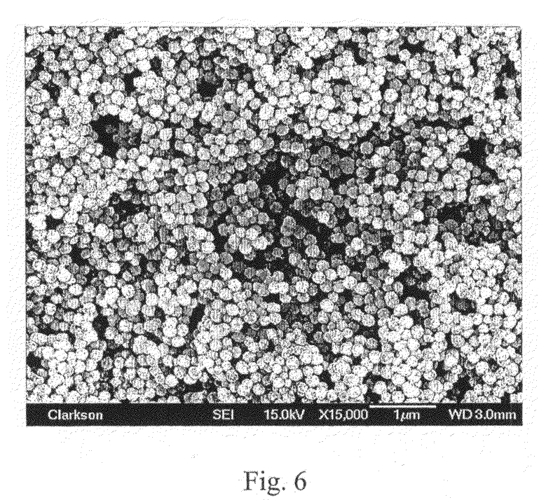

All experiments were carried out in a 1-liter 4-necked flask equipped with a refluxing condenser above a Dean-Stark trap and 7″ extension. Stirring was provided by a two-inch Teflon blade connected to a variable speed mixer. The amount of nickel carbonate used in the precipitation process was in general kept at 140 g (1.18 mole). NiCO₃ was added to 500 ml of a polyol mixture, composed of 50% PG, 50% DEG and 7 g PE. The dispersing agent, PE, was added to the polyol and heated to 70° C. with a heating mantle. The required amount of NiCO₃ was added at 80-85° C., after the PE had fully dissolved. The NiCO₃/polyol mixture was stirred at 500 RPM in all experiments. The mixture was continually heated (75% power to the heating mantle) until reduction was complete. The nickel powder was washed three times with ethanol (3×400 ml) and was filtered with a vacuum system using Whatman #50 filter paper. The powder was then dried overnight at 100° C. in a regular oven, yielding the particles shown in FIG. 6.

### Example 4

### Preparation of Ultra-Fine Silver Particles

All experiments were carried out in a 1-liter 4-necked flask equipped with a refluxing condenser above a Dean-Stark trap and 7″ extension. Stirring was provided by a two-inch Teflon blade connected to a variable speed mixer. The amount of silver carbonate used in the precipitation process was in general kept at 100 g. Ag₂CO₃ was added to 500 ml of a polyol mixture, composed of 50% PG, 50% DEG and 7 g PE. The dispersing agent was initially added to the polyol and mixed until completely dissolved; the required amount OfAg₂CO₃ was then added to the flask. The resulting mixture was stirred at 500 RPM in all experiments, with continual heating until the reduction to silver metal was complete.

1. A composition comprising a plurality of metal particles having an average diameter of 10 μm or less, wherein said metal particles comprise one or more elements selected from the group consisting of transitional metals and noble metals, and said particles are resistant to oxidation.

2. The composition of claim 1, wherein the oxygen content of the particles is less than 10% after exposure to air for 12 months at 20° C.

3. The composition of claim 1, wherein the oxygen content of the particles is less than 10% after exposure air for 120 minutes at 100° C.

4. The composition of claim 1, wherein the oxygen content of the particles is less than 10% after heating in air to 220° C. at 20° C./minute.

5. A composition comprising a plurality of copper particles having an average diameter N of 0.5 μm or less, wherein about 80% of the particles have a diameter within the range of N ±15% N.

6. The composition of claim 5, wherein at least about 85% of the particles have a diameter within the range of N ±15% N.

7. The composition of claim 6, wherein at least about 90% of the particles have a diameter within the range of N ±15% N.

8. The composition of claim 7, wherein 95% or more of the particles have a diameter within the range of N ±15% N.

9. The composition of claim 5, wherein the particles have a degree of crystallinity of at least 80%.

10. The composition of claim 9, wherein the particles have a degree of crystallinity of at least 90%.

11. The composition of claim 10, wherein the particles have a degree of crystallinity of at least 95%.

12. The composition of claim 11, wherein the particles have a degree of crystallinity of 99-100%.

13. The composition of claim 1, wherein the index of agglomeration I_{aggl} of the particles is about 1.2 or less.

14. The composition of claim 5, wherein the index of agglomeration I_{aggl} of the particles is about 1.2 or less.

15. The composition of claim 9, wherein the index of agglomeration I_{aggl} of the particles is about 1.2 or less.

16. The composition of claim 1, wherein the particles comprise one or more elements selected from the group consisting of Ag, Au, Co, Cr, Cu, Fe, In, Ir, Mn, Mo, Ni, Nb, Os, Pd, Pt, Re, Rh, Ru, Sn, Ta, Ti, V, W, and Zn.

17. The composition of claim 1, wherein the particles consist essentially of one or more elements selected from the group consisting of Ag, Au, Co, Cr, Cu, Fe, In, Ir, Mn, Mo, Ni, Nb, Os, Pd, Pt, Re, Rh, Ru, Sn, Ta, Ti, V, W, and Zn.

18. The composition of claim 17, wherein the particles consist essentially of copper.

19. The composition of claim 17, wherein the particles consist essentially of silver.

20. The composition of claim 17, wherein the particles consist essentially of nickel.

21. A composition comprising a plurality of ultra-fine metallic particles obtained by a process comprising:
(a) providing a reaction mixture comprising a metal precursor, a branched polyol dispersing agent, and an alcoholic reducing agent;
(b) adjusting the temperature of the reaction mixture to a reaction temperature sufficient to reduce the metal precursor to metallic particles; and
(c) maintaining the reaction mixture at the reaction temperature, thereby producing the plurality of ultra-fine metallic particles.

22. The composition of claim 21, wherein the branched polyol is pentaerythritol.

23. The metallic composition of claim 21, wherein the alcoholic reducing agent comprises one or more polyols selected from the group consisting of 1,2-propylene glycol, 1,3-propylene glycol, and diethyleneglycol.

24. The metallic composition of claim 22, wherein the alcoholic reducing agent comprises one or more polyols selected from the group consisting of 1,2-propylene glycol, 1,3-propylene glycol, and diethyleneglycol.

25. The metallic composition of claim 23, wherein the alcoholic reducing agent is a mixture of 1,2-propylene glycol and diethyleneglycol.

26. The metallic composition of claim 24, wherein the alcoholic reducing agent is a mixture of 1,2-propylene glycol and diethyleneglycol.

27. The metallic composition of claim 21, wherein the metal precursor is a metal carbonate.

28. The metallic composition of claim 27, wherein the metal precursor is copper(II) carbonate.

29. The metallic composition of claim 27, wherein the metal precursor is silver(I) carbonate.

30. The metallic composition of claim 27, wherein the metal precursor is nickel(II) carbonate.

31. The metallic composition of claim 21, wherein the process further comprises moderating the pH of the reaction mixture at pH 6 or above.

32. The metallic composition of claim 27, wherein the process further comprises moderating the pH of the reaction mixture at pH 6 or above.

33. The metallic composition of claim 28, wherein the process further comprises moderating the pH of the reaction mixture at pH 6 or above.

34. The metallic composition of claim 29, wherein the process further comprises moderating the pH of the reaction mixture at pH 6 or above.

35. The metallic composition of claim 30, wherein the process further comprises moderating the pH of the reaction mixture at pH 6 or above.

36. The metallic composition of claim 21, wherein the process further comprises moderating the pH of the reaction mixture at pH 7 or above.

37. The metallic composition of claim 27, wherein the process further comprises moderating the pH of the reaction mixture at pH 7 or above.

38. The metallic composition of claim 28, wherein the process further comprises moderating the pH of the reaction mixture at pH 7 or above.

39. The metallic composition of claim 29, wherein the process further comprises moderating the pH of the reaction mixture at pH 7 or above.

40. The metallic composition of claim 30, wherein the process further comprises moderating the pH of the reaction mixture at pH 7 or above.

41. The metallic composition of claim 21, wherein the process further comprises moderating the pH of the reaction mixture at pH 8 or above.

42. The metallic composition of claim 27, wherein the process further comprises moderating the pH of the reaction mixture at pH 8 or above.

43. The metallic composition of claim 28, wherein the process further comprises moderating the pH of the reaction mixture at pH 8 or above.

44. The metallic composition of claim 29, wherein the process further comprises moderating the pH of the reaction mixture at pH 8 or above.

45. The metallic composition of claim 30, wherein the process further comprises moderating the pH of the reaction mixture at pH 8 or above.

46. The metallic composition of claim 41, wherein the pH of the reaction mixture is moderated by introducing a buffering agent into the reaction mixture.

47. The metallic composition of claim 42, wherein the pH of the reaction mixture is moderated by introducing a buffering agent into the reaction mixture.

48. The metallic composition of claim 43, wherein the pH of the reaction mixture is moderated by introducing a buffering agent into the reaction mixture.

49. The metallic composition of claim 44, wherein the pH of the reaction mixture is moderated by introducing a buffering agent into the reaction mixture.

50. The metallic composition of claim 45, wherein the pH of the reaction mixture is moderated by introducing a buffering agent into the reaction mixture.

51. A method for forming a plurality of ultra-fine metallic particles comprising:
(a) providing a reaction mixture comprising a metal precursor, a branched polyol dispersing agent, and an alcoholic reducing agent;
(b) adjusting the temperature of the reaction mixture to a reaction temperature sufficient to reduce the metal precursor to metallic particles; and
(c) maintaining the reaction mixture at the reaction temperature, thereby producing the plurality of ultra-fine metallic particles.

52. The method of claim 51, wherein the branched polyol is pentaerythritol.

53-54. (canceled)

55. The method of claim 51, wherein the alcoholic reducing agent is a mixture of 1,2-propylene glycol and diethyleneglycol.

56. (canceled)

57. The method of claim 51, wherein the metal precursor is a metal carbonate.

58. The method of claim 57, wherein the metal precursor is copper(II) carbonate.

59. The method of claim 57, wherein the metal precursor is silver(I) carbonate.

60. The method of claim 57, wherein the metal precursor is nickel(II) carbonate.

61. The method of claim 51, wherein the process further comprises moderating the pH of the reaction mixture at a pH range from 6-8 or above.

62-75. (canceled)

76. The method of claim 61, wherein the pH of the reaction mixture is moderated by introducing a buffering agent into the reaction mixture.

77-80. (canceled)

81. The method of claim 76, wherein the buffering agent is a tertiary amine.

82-85. (canceled)

86. The method of claim 61, wherein the buffering agent is triethanolamine.

87-90. (canceled)

91. In a process for preparing metal powders by reduction of metal precursors with an alcoholic reducing agent, the improvement which consists of carrying out the reduction in a solvent comprising two or more glycols.

92. In a process for preparing metal powders by reduction of metal precursors with an alcoholic reducing agent, the improvement which consists of carrying out the reduction in the presence of a tertiary amine buffer.

93. In a process for preparing metal powders by reduction of metal precursors with an alcoholic reducing agent, the improvement which consists of carrying out the reduction in the presence of a branched polyol dispersing agent.

94. (canceled)

95. The improvement according to claim 91, wherein the two or more glycols comprise polyethylene glycol and diethylene glycol.

96. The improvement according to claim 91, wherein the reduction is carried out in the presence of a tertiary amine buffer.

97. The improvement according to claim 91, wherein the reduction is carried out in the presence of a branched polyol dispersing agent.

98. The improvement according to claim 91, wherein the reduction is carried out in the presence of a tertiary amine buffer and a branched polyol dispersing agent.

99-101. (canceled)

102. The improvement according to claim 92, wherein the tertiary amine buffer is triethanolamine.

103. The improvement according to claim 93, wherein the branched polyol dispersing agent is pentaerythritol.

104. (canceled)

105. A method of preparing 200 g or more of an ultra-fine metal powder having an average particle size of 1.2 μm or less, per liter of reaction mixture volume, by reducing a metal precursor with an alcoholic reducing agent according to the improvement of claim 91.

106-111. (canceled)

112. The improvement according to claim 96, wherein the tertiary amine buffer is triethanolamine.

113. The improvement according to claim 98, wherein the tertiary amine buffer is triethanolamine.

114-115. (canceled)

116. The improvement according to claim 97, wherein the branched polyol dispersing agent is pentaerythritol.

117. The improvement according to claim 98, wherein the branched polyol dispersing agent is pentaerythritol.

118-119. (canceled)
